(19) United States
(12) Patent Application Publication
(10) Pub. No.: US 2003/0110300 A1
(43) Pub. Date: Jun. 12, 2003

(54) Virtual storage interface device

(75) Inventor: Jerry Chen, Tu-Cheng City (TW)

Correspondence Address: Finnegan, Henderson, Farabow,, Garrett & Dunner, L.L.P., 1300 I Street, N.W., Washington, DC, 20005-3315, US

(73) Assignee: MICRO-STAR INT'L CO., LTD.

(21) Appl. No.: 10/012,535

(22) Filed: Dec. 12, 2001

(51) Int. Cl. G06F 15/16

(52) U.S. Cl. 709/249; 711/111

(57) ABSTRACT

In a virtual storage interface device, a virtual storage control unit is coupled to a first connector unit of a computer terminal via a second connector unit, and is further coupled to a network system via a network control unit. A processing unit is coupled to the network control unit and the virtual storage control unit, and controls transmission of outgoing data of the computer terminal received by the virtual storage control unit to the network system via the network control unit for storage of the outgoing data in a data storage device of the network system after performing a first data format transformation upon the outgoing data, and transmission of incoming data of the data storage received by the network control unit to the computer terminal via the virtual storage control unit and the second connector unit after performing a second data format transformation upon the incoming data.

### BACKGROUND OF THE INVENTION

1. Field of the Invention

The invention relates to a virtual storage interface device, more particularly to a virtual storage interface device that interconnects a computer terminal and a data storage device of a network system.

2. Description of the Related Art

FIG. 1 illustrates a plurality of conventional computers 3 in a network system. Each of the conventional computers 3 generally includes a data storage device, such as a hard disk drive 31, a floppy disk drive 32, and an optical disk drive 33, etc., for data storage. Since each of the data storage devices is accessed by a respective one of the conventional computers 3, it is not possible to manage effectively all of the data storage devices in the network system. Furthermore, the following are some of the drawbacks of the data storage device of the conventional computer 3 during use:

1. When the data storage device, such as the hard disk drive, with a fixed memory capacity is not enough for a user, there is a need to provide an additional hard disk drive, thereby resulting in inconvenience and difficulty during assembly of the additional hard disk drive. Further, when the floppy disk drive or the optical disk drive is used for data access, discs for data storage must be carefully preserved to prevent damage and loss, thereby resulting in inconvenience during use.

2. Since the data storage device, such as the hard disk drive, is directly coupled to a main module of the conventional computer, damage and data loss of the hard disk easily occur when the conventional computer is abnormally shut down.

3. When operating in multiple operating systems, it is difficult to partition or increase the data storage device.

### SUMMARY OF THE INVENTION

Therefore, the object of the present invention is to provide a virtual storage interface device for interconnecting a computer terminal and a data storage device of a network system such that the data storage device can be accessed by the computer terminal.

According to the present invention, a virtual storage interface device is adapted for interconnecting a computer terminal and a data storage device of a network system such that the data storage device is capable of being accessed by the computer terminal. The computer terminal is provided with a first connector unit configured for interfacing with at least one peripheral data storage medium. The virtual storage interface device comprises:

a second connector unit adapted to be coupled to the first connector unit;

a network control unit adapted to be coupled to the network system;

a virtual storage control unit coupled to the second connector unit and the network control unit and capable of receiving outgoing data of the computer terminal from the second connector unit and incoming data of the data storage device of the network system from the network control unit; and

a processing unit coupled to the network control unit and the virtual storage control unit,

the processing unit being operable so as to control transmission of the outgoing data received by the virtual storage control unit to the network system via the network control unit for storage of the outgoing data in the data storage device after performing a first data format transformation upon the outgoing data,

the processing unit being further operable so as to control transmission of the incoming data received by the network control unit to the computer terminal via the virtual storage control unit and the second connector unit after performing a second data format transformation upon the incoming data.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view showing a plurality of conventional computers in a network system;

FIG. 2 is a schematic circuit block diagram illustrating the preferred embodiment of a virtual storage interface device according to this invention;

FIG. 3 is a schematic view showing how the preferred embodiment is coupled to a network system having multiple data storage devices via a network hub;

FIG. 4 is a schematic view showing a computer motherboard; and

FIG. 5 is a schematic view showing an application utilizing the preferred embodiment in an office network system.

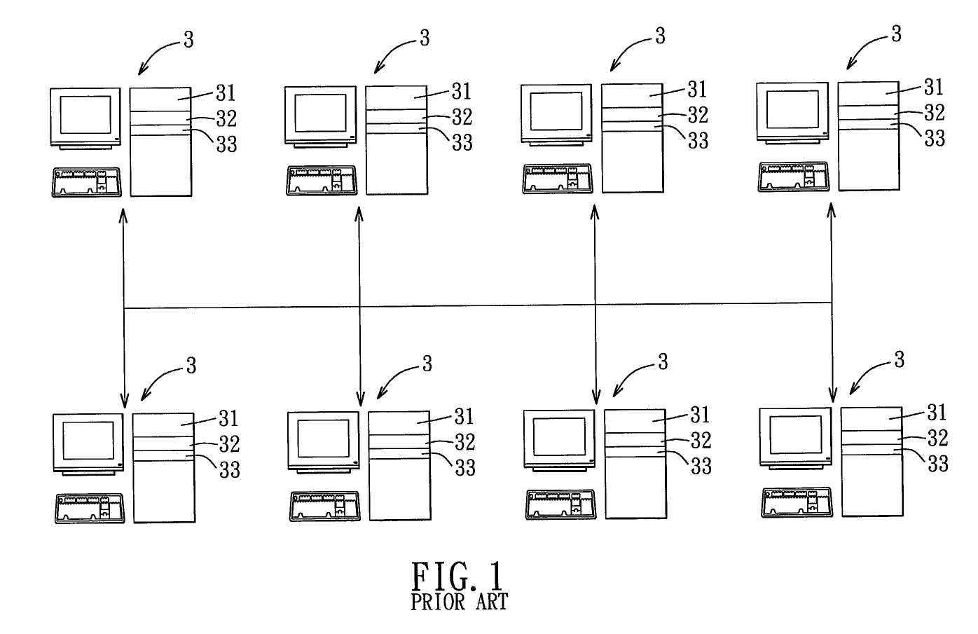

### DETAILED DESCRIPTION OF THE PREFERRED EMBODIMENT

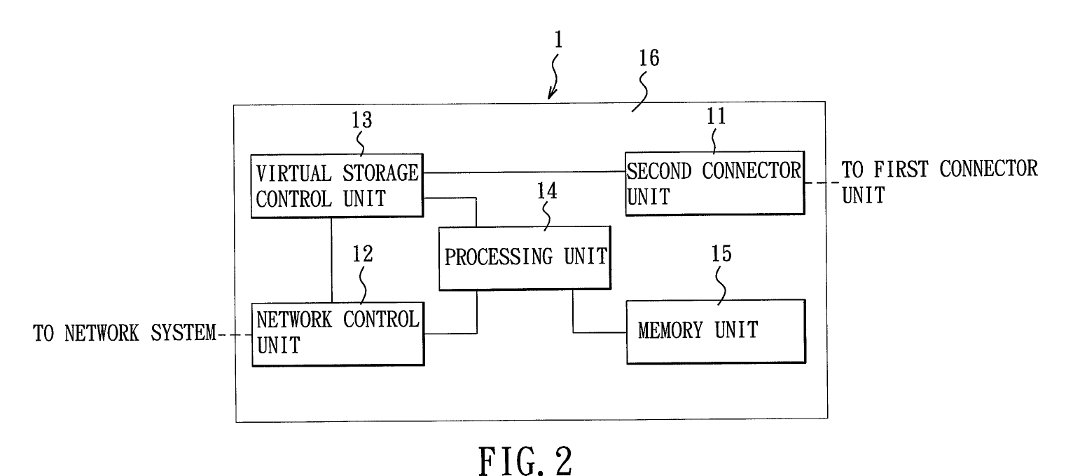

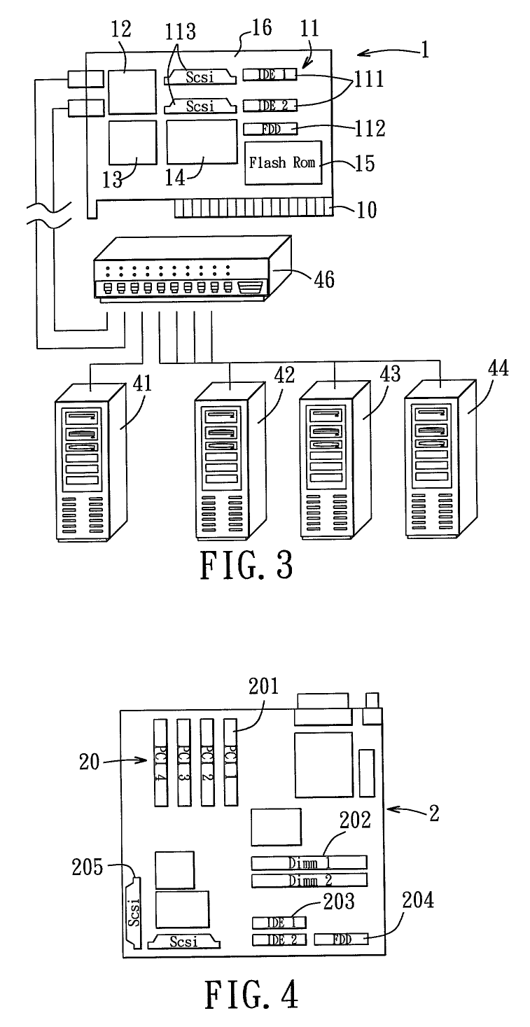

Referring to FIGS. 2 and 3, according to the preferred embodiment of this invention, a virtual storage interface device 1 is adapted for interconnecting a computer terminal and one of several data storage devices 41, 42, 43, 44 of a network system via a network hub 46 such that said one of the data storage devices 41, 42, 43, 44 is capable of being accessed by the computer terminal. In this embodiment, the computer terminal includes a motherboard 2, as shown in FIG. 4, that is provided with a first connector unit 20 configured for interfacing with at least one peripheral data storage medium. The first connector unit 20 includes four PCI slots 201, two DIMM slots 202, two IDE slots 203, a FDD slot 204 and two SCSI slots 205. The virtual storage interface device 1 is shown to include a circuit board 16, a second connector unit 11, a network control unit 12, a virtual storage control unit 13, and a processing unit 14.

The circuit board 16 has the second connector unit 11, the network control unit 12, the virtual storage control unit 13 and the processing unit 14 mounted thereon. The circuit board 16 further has a plug portion 10 (i.e., gold fingers) that is adapted to be plugged into one of the PCI slots 201 on the motherboard 2.

The second connector unit 11 is adapted to be coupled to the first connector unit 20. In this embodiment, the second connector unit 11 includes two IDE connectors 111, a FDD connector 112 and two SCSI connectors 113 adapted to be coupled to the IDE slots 203, the FDD slot 204 and the SCSI slots 205, respectively, via an external cable.

The network control unit 12 is adapted to be coupled to the network system. When the computer terminal is turned on, the network control unit 12 is operable so as to couple with at least a predetermined one of the data storage devices 41, 42, 43, 44, for example, the data storage device 41. The computer terminal is capable of loading and performing an operating system stored in the data storage device 41, and designating the data storage device 41 as a data storage medium. The data storage device 41 comprises a plurality of hard disk drives, each of which has a relatively large memory area for data storage.

The virtual storage control unit 13 is coupled to the second connector unit 11 (including the IDE connectors 111, the FDD connector 112 and the SCSI connectors 113) and the network control unit 12. The virtual storage control unit 13 is capable of receiving outgoing data of the computer terminal from the second connector unit 11, and incoming data of the data storage device 41 of the network system from the network control unit 12.

The processing unit 14 is coupled to the network control unit 12 and the virtual storage control unit 13. The processing unit 14 is operable so as to control transmission of the outgoing data received by the virtual storage control unit 13 to the network system via the network control unit 12 for storage of the outgoing data in the data storage device 41 after performing a first data format transformation, such as a data packet formation, upon the outgoing data. The processing unit 14 is further operable so as to control transmission of the incoming data received by the network control unit 12 to the motherboard 2 of the computer terminal via the virtual storage control unit 13 and the second connector unit 11 after performing a second data format transformation, such as packet data retrieval, upon the incoming data.

The virtual storage interface device 1 further includes a memory unit 15 coupled to the processing unit 14 and mounted on the circuit board 16. In this embodiment, the memory unit 15 is a Flash ROM that is adapted to provide an operating system and a data storage area to the computer terminal when the network control unit 12 is disconnected from the network system.

Accordingly, when the virtual storage interface device 1 is coupled to the computer terminal and the data storage device 41, and is set up in accordance with some relevant software, the data storage device 41 can act as a virtual HDD, FDD or MOD for the computer terminal. Therefore, when the computer terminal has outgoing data to be stored, the outgoing data is sent to the virtual storage control unit 13 via the first and second connector units 20, 11. The processing unit 14 then transforms the outgoing data into a data packet that is sent to the data storage device 41 for data storage via the network control unit 12. When the computer terminal is to read incoming data of the data storage device 41, the computer terminal generates a read signal that is received by the processing unit 14 via the first and second connector units 20, 11 and the virtual storage control unit 13 such that the processing unit 14 controls the network control unit 12 to retrieve the incoming data (in a data packet format) from the data storage device 41 and performs a data format transformation upon the incoming data. The incoming data is subsequently sent to the computer terminal via the virtual storage control unit 13, and the second and first connector units 11, 20.

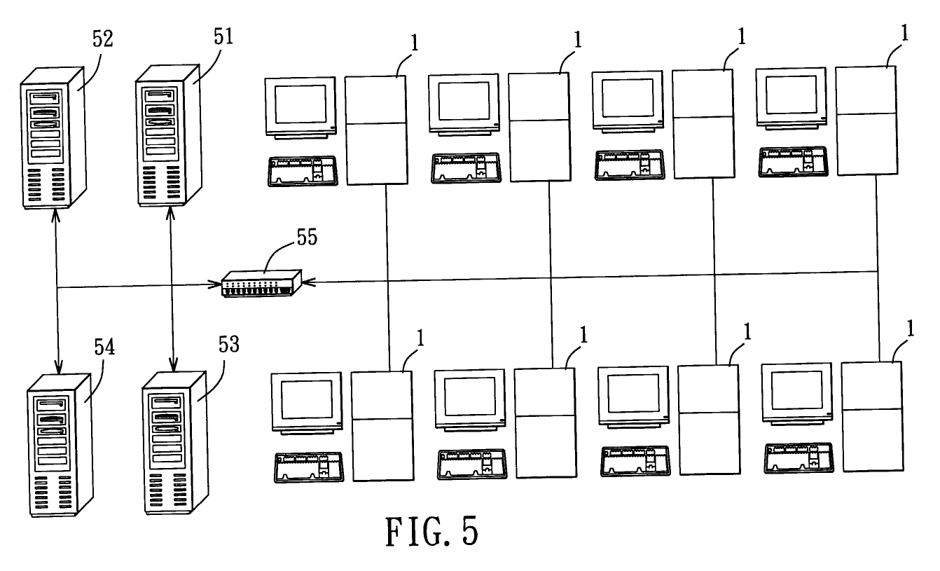

Referring to FIG. 5, the virtual storage interface device 1 of this invention can be installed in each of multiple computer terminals of another network system, such as an office network system. The network system is further provided with a plurality of data storage devices 51, 52, 53, 54 that are coupled to each computer terminal via a network hub 55 so as to form an internal local network. Therefore, due to the use of the virtual storage interface device 1 of this invention, the data storage devices 51, 52, 53, 54 are capable of being accessed by each computer terminal.

The following are some of the advantages of the present invention:

1. Through the virtual storage interface device 1, data stored in the data storage devices of the network system can be collected for centralized management. As such, when an operating system stored in the data storage devices is upgraded, all of the computer terminals in the network system can be loaded with the upgraded operating system.

2. Due to the use of this invention, the data storage devices provide a very large storage space for data storage such that the HDD, FDD and MOD installed in the conventional computer can be omitted, thereby resulting in relatively lower costs and a smaller computer size.

3. Due to the use of this invention, the data storage space in the data storage device can be conveniently partitioned.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A virtual storage interface device adapted for interconnecting a computer terminal and a data storage device of a network system such that the data storage device is capable of being accessed by the computer terminal, the computer terminal being provided with a first connector unit configured for interfacing with at least one peripheral data storage medium, said virtual storage interface device comprising:
a second connector unit adapted to be coupled to the first connector unit;
a network control unit adapted to be coupled to the network system;
a virtual storage control unit coupled to said second connector unit and said network control unit and capable of receiving outgoing data of the computer terminal from said second connector unit and incoming data of the data storage device of the network system from said network control unit; and
a processing unit coupled to said network control unit and said virtual storage control unit,
said processing unit being operable so as to control transmission of the outgoing data received by said virtual storage control unit to the network system via said network control unit for storage of the outgoing data in the data storage device after performing a first data format transformation upon the outgoing data,
said processing unit being further operable so as to control transmission of the incoming data received by said network control unit to the computer terminal via said virtual storage control unit and said second connector unit after performing a second data format transformation upon the incoming data.

2. The virtual storage interface device as claimed in claim 1, further comprising a memory unit coupled to said processing unit and adapted to provide an operating system and a data storage area to the computer terminal when said network control unit is disconnected from the network system.

3. The virtual storage interface device as claimed in claim 2, further comprising a circuit board having said second connector unit, said network control unit, said virtual storage control unit, said processing unit and said memory unit mounted thereon.

4. The virtual storage interface device as claimed in claim 1, further comprising a circuit board having said second connector unit, said network control unit, said virtual storage control unit, and said processing unit mounted thereon.

5. The virtual storage interface device as claimed in claim 1, wherein said second connector unit includes at least one of an IDE connector, a FDD connector, and a SCSI connector.
